(19) United States
(12) Patent Application Publication
(10) Pub. No.: US 2026/0257562 A1
(43) Pub. Date: Sep. 3, 2026

(54) Method for Operating an Electric Machine of a Vehicle

(71) Applicant: Bayerische Motoren Werke Aktiengesellschaft, Muenchen (DE)

(72) Inventors: Kilian LUDWICZEK, Muenchen (DE); Christian TETEK, Muenchen (DE)

(21) Appl. No.: 18/881,637

(22) PCT Filed: Jul. 3, 2023
(86) PCT No.: PCT/EP2023/068152

§ 371 Date: Jan. 6, 2025

(30) Foreign Application Priority Data
Jul. 25, 2022 (DE) 10 2022 118 552.4

(51) Int. Cl. B60L 7/18

(52) U.S. Cl. CPC B60L 7/18; B60L 2240/12; B60L 2240/423; B60L 2250/26; B60L 2260/24; B60L 2260/30

(57) ABSTRACT

A method for operating an electric machine of a vehicle includes influencing an electric recuperation signal of the electric machine.

### BACKGROUND AND SUMMARY

The invention relates to a method for operating an electric machine of a vehicle, wherein an electric recuperation signal of the electric machine is influenced. The invention also relates to an electric machine and a vehicle.

Compared to conventional combustion-based motor vehicles, electric vehicles are characterized by a smooth driving behavior. For example, electric cars typically have only one gear, which allows for uninterrupted acceleration without shifting. In addition, an electric motor can deliver its full torque from the outset without first having to reach high speeds. In contrast, combustion engines require high speeds to be able to deliver high power and torque. This in turn results in a typical noise development and haptically perceptible vibrations and kinetics, whereby users of the vehicle can have an atmospheric background to a driving experience.

In comparison to conventional vehicles, electric vehicles do not intend to create such emotionalization of the driving behavior. Particularly in coasting mode, various typical driving behavior patterns are clearly perceptible in conventional vehicles, such as coasting burbling or an uneven combustion engine running behavior, whereby greater emotionalization can be achieved.

Against this background, one object of the invention is to improve a method for operating an electric machine of a vehicle. In particular, it should be possible to design and/or adapt a driving behavior of the vehicle operated by the electric machine in order to enable emotionalization for a vehicle user.

This object is achieved by a method for operating an electric machine of a vehicle, an electric machine, and a vehicle having the features disclosed herein. The present disclosure also relates to advantageous developments of the invention.

According to a first aspect, a method for operating an electric machine of a vehicle is indicated, in which an electric recuperation signal of the electric machine in a coasting phase of the vehicle is influenced by an artificially generated electric signal.

This can be used to change and/or modify a recuperation behavior, a recuperation power and/or recuperation phases of the electric machine, for example in order to influence a drive power transmitted by the electric machine to a drive of the vehicle and thus to control or modulate a driving behavior of the vehicle. This can, for example, stimulate a haptic perception of a driver or occupant in order to emotionalize a driving experience.

For the present disclosure, a coasting phase is defined as a driving state of the vehicle in which, if the power is not disconnected, a drive or the engine is coasted by the vehicle, i.e. kept in a rotating or driving motion. This coasting phase is used in electric vehicles and in particular in hybrid vehicles to use the energy released during coasting to charge a high-voltage battery. Typically, energy recuperation during coasting is carried out at only a low recuperation power. This recuperation power can be artificially increased and/or decreased by the artificially generated electric signal, which can, for example, cause an—in particular increased—deceleration of the vehicle which can be perceived by an occupant.

Vehicles with an electric machine or electric drive, such as pure electric vehicles or hybrid vehicles, usually include a recuperation system that can be used to recover some of the kinetic energy during deceleration or in the coasting phase of the vehicle (recuperation). During recuperation, the electric drive or the electric machine is operated in generator mode and can thus convert the kinetic energy released when the vehicle decelerates into electric energy. The recovered electric energy is stored in an electric energy storage device, such as the battery of the vehicle, and can be used again in particular in other driving situations to drive the vehicle or to supply electrical consumers. In particular, recuperation improves the efficiency of the vehicle, since only a relatively small remaining portion of the deceleration is converted into heat loss by a service brake.

In such a recuperation mode, an electric recuperation signal is generated, for example, to output it to a drive of the vehicle. A recuperation signal can be, for example, an energy signal or a power signal and/or be generated as a function of a recoverable or producible kinetic or electric power. This recuperation signal can, for example, be provided at the electric machine, the drive and/or a control unit of the electric machine and/or the drive and/or be transmitted to these.

Here, an artificially generated electric signal is, in particular, a signal that is superimposed on an unloaded output signal of a recuperation system of the electric machine, in particular to achieve emotionalization of driving, in particular when coasting, via an irregular torque input or output of the electric machine.

The artificially generated electric signal can have an origin outside and/or inside the electric machine and can be an energy signal or a power signal. To influence the recuperation signal, the artificially generated electric signal can be linked or mixed with the recuperation signal to change the energy flow signal of the recuperation.

The invention is now based, inter alia, on the idea of modifying an unloaded output signal of a recuperation system of the electric machine by a further, artificially provided signal (i.e. in particular not or not exclusively dependent on a recuperation request from the vehicle operation)—in other words by an artificially generated electric signal—in such a way that a modified recuperation signal is generated, in particular in order to be able to use the physical effects of this modified recuperation signal on the electric machine, the drive, the vehicle and/or its driving behavior.

In particular, the recuperation of energy can be influenced as a function of a specific deceleration request from the driver or the system by the artificially generated electric signal in such a way that a (higher) recuperation power is applied such that the recuperation power, for example, leads to a temporary and/or periodic vehicle deceleration that is, in particular, greater than the vehicle deceleration achieved during coasting (with or without recuperation). The deceleration achieved can even be significantly higher than during normal coasting or during coasting with normal recuperation, because the driver expects or even desires an appropriate driving behavior or braking of the vehicle. For example, vehicle or trip data and/or sensor signals can be evaluated to detect a deceleration request from the driver and/or the system.

In one embodiment, the artificially generated electric signal can cause load fluctuations in the electric machine. In this context, load fluctuations describe a change over time in the strength of influences on the electric machine or a recuperation mode of the electric machine in the coasting phase. This means that load fluctuations that occur in a motor vehicle with an internal combustion engine during coasting phases, such as a coasting burbling, can be simulated using the modified recuperation signal. In other words, in coasting phases that are to be emotionalized, the recuperation can be specifically modulated by the proposed method in order to imitate a sporty driving experience, similar to a conventional vehicle, and to make it perceptible for a driver and/or occupant of the vehicle. In particular, a level of the recuperation power and/or the magnitude of a deceleration of the vehicle can be predetermined as a function of a duration and/or intensity and/or the type of at least one specific vehicle and/or trip parameter—or vehicle and/or trip parameter to be specified—such as, for example, the dynamics of a reduction in the operation of an accelerator pedal.

In one embodiment, the artificially generated electric signal may be periodic or may have periodic components. For example, the artificial signal can be periodically ascending or periodically descending in order to produce respective haptically perceptible effects in the drive and in the driving behavior of the vehicle. This allows various phenomena, in particular those known to users of vehicles powered by internal combustion engines, to be simulated in order to emotionalize the driving behavior of the electric-powered vehicle.

In one embodiment, the artificially generated electric signal can influence a frequency of the recuperation signal. In particular, by changing the frequency, a temporal sequence of mechanical effects of superimposed recuperation phases can be changed, for example as a function of a vehicle speed, in particular to enable drive reactions that can be perceived harmoniously by a driver.

In one embodiment, the artificially generated electric signal can influence an amplitude of the recuperation signal. By changing the amplitude of the energy or power flow, a perceptible strength or intensity of recuperation-related effects, such as load fluctuations, can be changed to allow emotionalization of the driving behavior for the driver.

In one embodiment, the artificially generated electric signal can be provided by an energy source or an energy sink. An energy source can provide energy, in particular by converting it from another form of energy. An energy sink can be an electrical consumer that is designed to convert recuperation energy into other forms of energy or other forms of electrical energy and to derive a direct or indirect benefit from this.

In one embodiment, the artificially generated electric signal can be provided by a control signal or can be a control signal. In this case, the control signal can be provided in particular by a control unit of the electric machine or a vehicle control system. The control signal can be used, for example, to cause the electric machine to generate more energy by recuperation, which can cause the drive to brake in order to influence a driving behavior. Thus, for example, various parameters of the vehicle can be used to determine a specific control of the electric machine and an associated recuperation behavior in order to achieve the desired effects in the driving behavior of the vehicle.

In one embodiment, the recuperation signal can be influenced depending on a vehicle speed. For example, a strength or a temporal sequence of haptically perceptible load fluctuations can be determined and applied depending on the current vehicle speed in order to be able to reproduce a desired driving behavior as realistically as possible.

In one embodiment, the recuperation signal can be influenced as a function of an operating gradient of an accelerator pedal of the vehicle. In particular, an accelerator pedal can be a foot-operated electronic control unit or an instrument for controlling an acceleration and/or braking process. Alternatively or additionally, a generated braking pressure, brake pedal travel and/or accelerator pedal angle, release gradient of the accelerator pedal and/or operating gradient of the brake pedal and/or the vehicle deceleration desired by the driver can be used to determine a suitable artificially generated electric signal for influencing the original recuperation signal. In particular, the dynamics of a reduction in operation of the accelerator pedal can be taken into account when determining and/or generating the artificially generated electric signal. Thus, not only the position of the accelerator pedal is relevant, but also the dynamics of the reduction.

In one embodiment, the recuperation signal can be influenced depending on a base recuperation level of the electric machine. In this case, the recuperation level can be adjustable to allow for control of the energy recovery adapted to the traffic situation. To be able to achieve a haptically perceptible effect, it may therefore be necessary to adapt the artificially generated electric signal to the currently underlying or applied recuperation level.

An additional aspect proposes an electric machine for a vehicle, comprising a control unit that is set up to influence an electric recuperation signal of the electric machine in a coasting phase of the vehicle by an artificially generated electric control signal. The advantages of the proposed electric machine essentially correspond to the advantages of the proposed method, which are explained in detail above, and so it is not necessary to repeat them here.

An additional aspect proposes a vehicle comprising an electric machine, wherein the electric machine is set up to perform a method described herein and/or is formed in the manner described herein. The present invention is particularly suitable for hybrid vehicles and electric vehicles, but is not limited to this field of application.

Further features, advantages and possible applications of the invention will become apparent from the following description in conjunction with the figures. In general, features of the various exemplary aspects and/or embodiments described herein may be combined with one another, unless this is clearly precluded in the context of the disclosure.

In the following part of the description, reference is made to the figures shown to illustrate specific aspects and embodiments of the present invention. It is understood that other aspects may be used and that structural or logical changes may be made to the illustrated embodiments without departing from the scope of the present invention. The following description of the figures is therefore not to be understood as restrictive.

### BRIEF DESCRIPTION OF THE DRAWINGS

FIG. 1 shows a schematic representation of a flow chart of a method according to the present disclosure for operating an electric machine of a vehicle.

FIG. 2 shows an exemplary embodiment of a vehicle according to the present disclosure in a schematic representation.

### DETAILED DESCRIPTION OF THE DRAWINGS

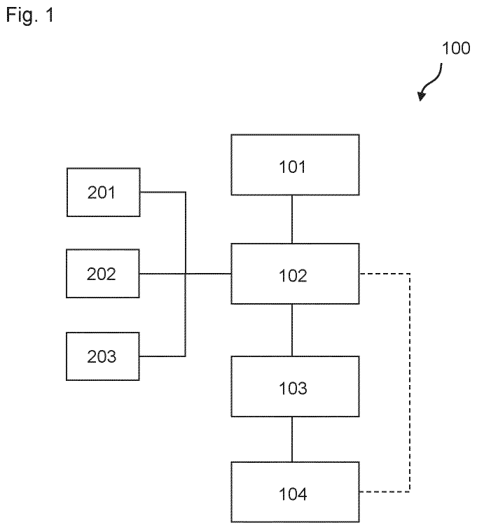

FIG. 1 shows a flow chart of an exemplary embodiment of a method 100 according to the present disclosure for operating an electric machine of a vehicle in a schematic representation.

The flow chart starts in a first step 101, whereby an electric recuperation signal, in particular an unloaded electric recuperation signal, is generated by the electric machine during a coasting phase of the vehicle.

In a second step 102, an artificial electric signal is determined as a function of a specific vehicle speed 201 or a vehicle speed 201 to be determined, a specific operating gradient 202 of an accelerator pedal of the vehicle or an operating gradient 202 of an accelerator pedal of the vehicle to be determined and a specific base recuperation level 203 of the electric machine or a base recuperation level 203 of the electric machine to be determined. This can be done, for example, by a control unit of the electric machine.

The artificial electric signal is generated in a step 103. In this step, an energy sink in the form of an additional consumer can be controlled in such a way that it demands a higher recuperation power from the electric machine. In this case, the artificially generated electric signal can be periodic or have periodic components.

In a step 104, the electric recuperation signal 101 is influenced by the artificially generated electric signal 103 in order to generate a modified recuperation signal. Optionally, the recuperation signal from step 104 can also be included as feedback in the calculation in step 102 and the artificial electric signal determined in this way can be modified again. In this manner, a recuperation mode of the electric machine can be modified as a function of at least one operating parameter of the vehicle in order to cause load fluctuations in the electric machine.

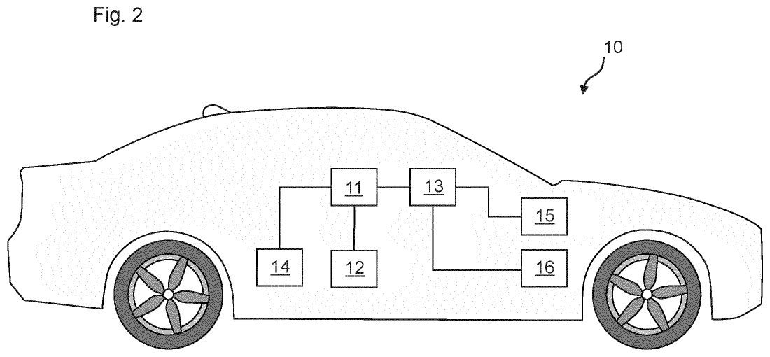

FIG. 2 shows a vehicle 10 according to the present disclosure, which has an electric machine 11, a high-voltage battery 12 for storing recuperation energy, a drive 14, a speed sensor 15 and a pedal sensor 16. The pedal sensor 16 can determine an accelerator pedal gradient influenced by operation of an accelerator pedal of the vehicle 10. The electric machine, for its part, comprises a control unit 13 and is set up to generate an electric recuperation signal in a coasting phase of the vehicle 10, in particular as a function of a recuperation power.

Depending on the detected accelerator pedal gradient and a detected vehicle speed, the control unit 13 can generate an artificially generated electric signal in order to influence the electric recuperation signal of the electric machine 11, thereby for example changing a power output to the drive 14. This can for example be used to set a recuperation power over time in order to generate load fluctuations at the electric machine 11.

### LIST OF REFERENCE SIGNS

10 vehicle
11 electric machine
12 high-voltage battery
13 control unit
14 drive
15 speed sensor
16 pedal sensor
100 method
101 to 104 steps
201 to 203 vehicle and trip parameters

1-12. (canceled)

13. A method for operating an electric machine of a vehicle comprising:
influencing an electric recuperation signal of the electric machine in a coasting phase of the vehicle by an artificially generated electric signal.

14. The method according to claim 13,
wherein the artificially generated electric signal causes load fluctuations of the electric machine.

15. The method according to claim 13,
wherein the artificially generated electric signal is periodic.

16. The method according to claim 13,
wherein the artificially generated electric signal influences a frequency of the recuperation signal.

17. The method according to claim 13,
wherein the artificially generated electric signal influences an amplitude of the recuperation signal.

18. The method according to claim 13,
wherein the artificially generated electric signal is provided by an energy source or an energy sink.

19. The method according to claim 13,
wherein the artificially generated electric signal is provided by a control signal.

20. The method according to claim 13,
wherein the recuperation signal is influenced as a function of a vehicle speed.

21. The method according to claim 13,
wherein the recuperation signal is influenced as a function of an operating gradient of an accelerator pedal of the vehicle.

22. The method according to claim 13,
wherein the recuperation signal is influenced as a function of a base recuperation level of the electric machine.

23. An electric machine for a vehicle comprising:
a controller configured to:
influence an electric recuperation signal of the electric machine in a coasting phase of the vehicle by an artificially generated electric signal.

24. The electric machine according to claim 23,
wherein the artificially generated electric signal causes load fluctuations of the electric machine.

25. The electric machine according to claim 23,
wherein the artificially generated electric signal is periodic.

26. The electric machine according to claim 23,
wherein the artificially generated electric signal influences a frequency of the recuperation signal.

27. The electric machine according to claim 23,
wherein the artificially generated electric signal influences an amplitude of the recuperation signal.

28. The electric machine according to claim 23,
wherein the artificially generated electric signal is provided by an energy source or an energy sink.

29. The electric machine according to claim 23,
wherein the artificially generated electric signal is provided by a control signal.

30. The electric machine according to claim 23,
wherein the recuperation signal is influenced as a function of a vehicle speed.

31. The electric machine according to claim 23,
wherein the recuperation signal is influenced as a function of an operating gradient of an accelerator pedal of the vehicle.

32. The electric machine according to claim 23,
wherein the recuperation signal is influenced as a function of a base recuperation level of the electric machine.
